(19) United States
(12) Patent Application Publication
(10) Pub. No.: US 2025/0137872 A1
(43) Pub. Date: May 1, 2025

(54) DISTRIBUTED WITNESS INTEGRITY SENSING PLATFORM

(71) Applicant: Analog Devices, Inc., Wilmington, MA (US)

(72) Inventors: Yosef STEIN, Sharon, MA (US); Seth S. KESSLER, West Newton, MA (US); Hazarathaiah MALEPATI, Farmington, CT (US); Armindo B. CHAVES, Hudson, MA (US); Michael BORGEN, Wilmington, MA (US); Christopher T. DUNN, Wenham, MA (US)

(21) Appl. No.: 19/010,543

(22) Filed: Jan. 6, 2025

Related U.S. Application Data
(63) Continuation-in-part of application No. 17/392,565, filed on Aug. 3, 2021, now Pat. No. 12,219,306.
(60) Provisional application No. 63/060,999, filed on Aug. 4, 2020.

(51) Int. Cl. G01M 5/00; G06F 13/42

(52) U.S. Cl. CPC G01M 5/0033; G06F 13/4247

(57) ABSTRACT

In an aspect, a system and method are provided for witness integrity sensing. In an aspect, the system includes structural integrity sensing elements and edge modules. Each of the edge modules is connected to a respective structural integrity sensing element. The system further includes an interface unit having a host interface side and a network interface side. The network interface side is configured to collect daisy chain sensing network data and selectively power respective structural integrity sensing elements, through selective ones of the plurality of edge modules. The system also includes a daisy-chain communication link connecting the interface unit to each of the edge modules in series, wherein each of the edge modules transmits a respective data signal to the interface unit, and wherein the daisy-chain communication link ends at a network terminator.

### CROSS REFERENCE TO RELATED APPLICATIONS

This application is related to and is a continuation-in-part of U.S. Non-Provisional patent application Ser. No. 17/392,565 entitled “Distributed Witness Integrity Sensing Platform” filed on Aug. 3, 2021, which claims the benefit of and priority to U.S. Provisional Patent Application No. 63/060,999 entitled “Distributed Witness Integrity Sensing Platform” filed Aug. 4, 2020, the contents of which applications are hereby incorporated by reference herein in their entireties.

### FIELD OF THE DISCLOSURE

The present invention relates to a sensor system, including a wireless sensor system.

### BACKGROUND

Helicopters, airplanes, rotorcraft, and other vehicle structure integrity sensing is used to detect cracks, corrosion, and other structural changes to the vehicle. Structural integrity sensing is often done in legacy devices by mounting a cluster of wireless sensors in hard-to-reach hotspot locations. In such a case, 1:1 radio frequency (RF) energy harvesting sensors may be powered from a near-by mounted renewable (RE) energy exciter. In legacy devices, the RE energy exciter uses a steering mechanism, such as a mechanical or phased array steering mechanism, to turn toward and transmit a wireless signal to each one of the wireless sensors within a cluster. Each wireless sensor then converts the wireless signal to power. However, steering the RF energy exciter for powering each of multiple sensors can present difficulties. Furthermore, sensors are often positioned in hard-to-reach places, and accessing the sensors to retrieve sensor data can be problematic.

As used herein, the term “WISP” may be interpreted as an acronym that stands for “witness integrity sensing platform.” In other embodiments, the term “WISP” may be an acronym that stands for “wireless integrity sensing platform” or some other appropriate definition.

### SUMMARY

Systems and methods are provided for communicating with and providing power to multiple sensors positioned in an enclosed space. According to an aspect, a system for witness integrity sensing is provided. The system includes a plurality of structural integrity sensing elements. The system further includes a plurality of edge modules. Each of the plurality of edge modules is connected to a respective structural integrity sensing element of the plurality of structural integrity sensing elements. The system also includes an interface unit having a host interface side and a network interface side. The network interface side is configured to collect daisy chain sensing network data and selectively power respective structural integrity sensing elements of the plurality of sensing elements, through selective ones of the plurality of edge modules. The system additionally includes a daisy-chain communication link connecting the interface unit to each of the plurality of edge modules in series. Each of the plurality of edge modules transmits a respective data signal to the interface unit. The daisy-chain communication link ends at a network terminator.

According to another aspect, a method for witness integrity sensing is provided. The method includes providing power from a local power sourcing device to an interface unit over a wired link segment. The method further includes powering, from the interface unit, respective sensing elements of a plurality of sensing elements. Each sensing element of the plurality of sensing elements is connected to a respective edge module of a plurality of edge modules. The plurality of edge modules are connected to the interface unit via a daisy-chain configuration terminated by a terminating device. The method also includes collecting sensed data from each of the plurality of sensing elements via the wired link segment.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 depicts an example of a distributed witness integrity sensing platform (WISP) architecture including a base module connected to multiple edge modules, in accordance with examples of the disclosure;

FIG. 2 is a diagram illustrating an exemplary inductive exciter module for charging a WISP device, according to various examples of the disclosure;

FIG. 3 depicts another example of a distributed witness integrity sensing platform (WISP) architecture including a base module connected to multiple second modules, in accordance with examples of the disclosure;

FIG. 4 illustrates an example of a distributed WISP architecture, an exciter, and a reader, in accordance with various examples of the disclosure;

FIG. 5 is diagram illustrating a distributed WTSP architecture coupled to a HUMS device, in accordance with various examples of the disclosure;

FIG. 6 is a diagram illustrating distributed WISP architecture in an enclosed space, in accordance with various examples of the disclosure;

FIG. 7 is a diagram illustrating a second module and a sensor element, in accordance with various examples of the disclosure;

FIG. 8 shows an energy harvesting antenna coupled to a first module, in accordance with various examples of the disclosure; and.

FIG. 9 depicts a block diagram illustrating an exemplary computing system that may be used for multi-sensor witness integrity sensing, according to some examples of the disclosure.

FIG. 10 shows another exemplary distributed witness integrity sensing platform (WISP) architecture, in accordance with an example aspect.

FIG. 11 shows yet another exemplary distributed witness integrity sensing platform (WISP) architecture, in accordance with an example aspect.

FIG. 12 described below shows an edge module and integrated sensor, in accordance with an example aspect.

FIG. 13 shows a flowchart of a method for witness integrity sensing, in accordance with an example aspect.

FIG. 14 shows a flow diagram further illustrating blocks of the method of FIG. 13, in accordance with an example aspect.

FIG. 15 shows a flow diagram further illustrating a block of the method of FIG. 13, in accordance with an example aspect.

FIG. 16 shows a flow diagram further illustrating another block of the method of FIG. 13, in accordance with an example aspect.

### DETAILED DESCRIPTION

In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense.

Generally, embodiments heroin relate to a distributed multi-sensor witness integrity sensing platform (WISP) approach which allows for positioning of sensors in an enclosed space. In particular, a base module is positioned outside of the enclosed space, and includes a processor, a sensor interface, and a transceiver. In some examples, the base module is a wireless module and includes an energy harvester, for converting received wireless transmissions into energy. In other examples, the base module includes a wired power source. The base module is coupled to one or more edge modules, which can be positioned within the enclosed space. Each edge module is coupled to a sensing element.

In some examples, the edge modules are connected to the base module with a wired connection. In various examples, the wired connection is a RS485 connection. In particular, a first edge module is connected to the base module and also to a second edge module. The second edge module is further connected to a third edge module. Multiple edge modules can be connected in this manner, via a daisy-chain, until a network terminator is reached indicating the end of the edge module chain.

In another implementation, the base module is connected to multiple edge modules using a wired I2C connection, and each edge module includes an I2C-ADC, a sensor signal conditioning element, and a sensing element. In particular, using an I2C configuration, two wires can be used to connect the base module to any number of sensors. VCC and ground are also sent across the bus to power the edge modules. I2C (or inter-integrated circuit bus) is a communication protocol having two wires, including a serial data line for sending and receiving data between a master and slave.

In yet another implementation, the base module is connected to multiple edge modules using a 1-Wire® connection. In particular, using a 1-Wire® configuration, one wire plus a ground reference can be used to connect the base module to any number of sensors.

The basis of 1-Wire® technology is a serial protocol using a single data line plus ground reference for communication. A 1-Wire® master initiates and controls the communication with one or more 1-Wire® slave devices on the 1-Wire® bus. In an aspect, each 1-Wire® slave device has a unique, unalterable, factory-programmed, 64-bit identification number (ID), which serves as device address on the 1-Wire® bus. The 8-bit family code, a subset of the 64-bit ID, identifies the device type and functionality. 1-Wire® is a voltage-based digital system that works with two contacts, data and ground, for half-duplex bidirectional communication. While in some aspects, the invention is described with respect to using 1-Wire®, other aspects may use a different protocol involving a single line for power and data transmission along with a ground reference.

Typical applications for 1-Wire devices include, but are not limited to, identification and authentication of consumables, rack cards, PCBs, computer accessories, and the protection of Intellectual Property (e.g., cloning prevention). Special uses include, but are not limited to, access control, asset management, guard tour systems, time and attendance, electronic cash, and temperature monitoring for food and pharmaceutical safety.

While both I2C and 1-Wire® are serial communication protocols, the key difference is that I2C uses two wires (data and clock) for faster data transfer, while 1-Wire® uses only one wire, allowing for longer cable lengths and lower power consumption, but at a significantly slower speed; making 1-Wire® ideal for applications where long distance communication with a few sensors is needed, while I2C is better for higher-speed data transfer between multiple devices close together.

Typically, 1-Wire® slave devices operate over the following four voltage ranges: 1.71V (min) to 1.89V (max); 1.71V (min) to 3.63V (max); 2.97V (min) to 3.63V (max); and 2.8V (min) to 5.25V (max). Most 1-Wire® devices such as sensors have no pin for a power supply; these 1-Wire® devices take their energy from a 1-Wire® bus (parasitic power supply).

According to various implementations, splitting up the WISP system into two modules (a base module and an edge module) and connecting the two modules using a wired connection (such as RS485 or I2C or 1-Wire®) allows multiple sensors to be placed in an enclosed (and generally inaccessible) location. The senor data can be transmitted via the wired connection to the base module. Additionally, the use of the two module system with wired connection, as provided herein, allows the sensors to be positioned many meters away from the base module In various examples, the sensors can be positioned five, ten, fifteen, twenty, fifty, one hundred, two hundred, three hundred, four hundred, five hundred, or more than five hundred meters away from the base module.

In contrast, in a single-module system with the one module connected to multiple sensors, the sensors can only be about a meter or two meters from the module, because the longer the wires, the more the signal becomes distorted by the resistance inherent in the connection. Placing the single module closer to the desired location of the sensors can make it extremely difficult, if not impossible, to provide power or charge to the module when the desired location is in a generally inaccessible location.

In various implementations, the distributed WISP architectures described herein can be used in many different types of locations. For example, the distributed WISP architecture can be used in a vehicle (e.g., a helicopter, a rotorcraft, an airplane, a ship, a tank, a truck, a car, etc.). Tn other examples, the distributed WISP is used in a non-vehicular environment such as a building or some other structure.

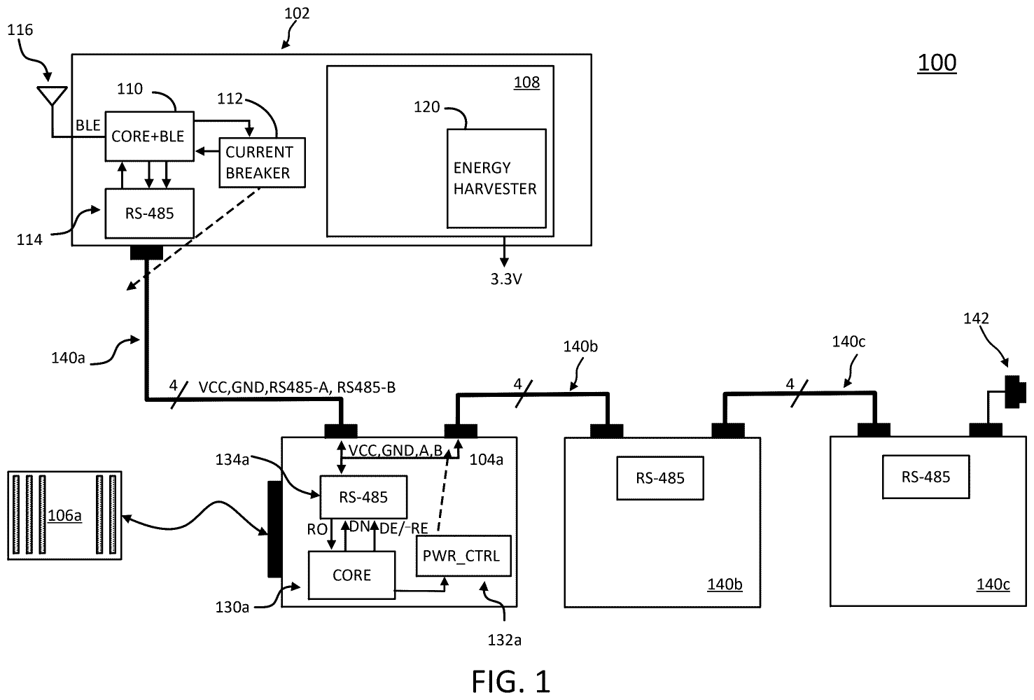

FIG. 1 shows a distributed witness integrity sensing platform (WISP) architecture 100 including a base module 102 connected to multiple edge modules 104a, 104b, 104c, according to various embodiments of the disclosure. In particular, the base module 102 is connected to a first edge module 104a via a first wired connection 140a. The first wired connection 140a transmits power from the base module 102 to the first edge module 104a, and the first wired connection 140a transmits data from the first edge module 104a to the base module 102.

The base module 102 includes a power management unit 108 having an energy harvester 120 and energy storage, a processor 110, a base communication component 114, a current breaker 112, and an antenna 116. The first module 102 receives power at the energy harvester 120.

In some examples, the energy harvester 120 includes an antenna and receives the signals from a hotspot mounted transceiver. In some examples, the wireless signals received at the energy harvesting antenna include inductive energy, and in other examples, the signals received at the energy harvesting antenna include radiofrequency energy. In some examples, inductive harvested energy is between about 30 mW and 330 mW. In other examples, the wireless signals are radiofrequency signals and may be in accordance with an ISM RF band and/or a RFID protocol. The energy harvester 120 transmits the harvested energy to storage, where it is accessed by other elements of the base module 102. Additionally, the energy harvested by the energy harvester 120 is transmitted to the edge modules 104a, 104b, 104c and provides power to the edge modules 104a, 104b, 104c. In some examples, the power management unit 108 provides between about 10 mA to 100 mA of current. In some examples, the power management unit 108 provides about 3.3 V of voltage.

The power management unit 108 manages the extracted power. The energy storage element and power management unit 108 include one or more circuit elements, which can be active or passive. In some examples, the charge storage element includes multiple capacitors. In some examples, the charge storage element includes one or more batteries. In some implementations, the power management unit receives a DC signal as input. The power management unit 108 outputs power to the processor unit 110 and transceiver, as well as to the output line 140a. The power management unit 108 retrieves energy from the energy storage element to provide power to other WISP elements.

The power management unit 108 is coupled to the core element 110, which includes a processor and a transceiver. The processor can include a printed circuit board, and the printed circuit board can be a digital printed circuit board. The printed circuit board can include active and passive circuit elements. In some examples, the transceiver is coupled to an antenna 116. In some examples, the transceiver is a Bluetooth low energy (BLE) transceiver. In various examples, the processor is a single or multi-core processor, an M4-core processor, or some other type of processor.

According to various implementations, the processor of the core element 110 is configured to perform cluster-based edge-integrity analytics. Specifically, the processor is configured to receive digitized sensed data from the various edge modules 104a-104c via the communication line 140 (including lines 140a, 140b, 140c), as described in greater detail below. In some examples, the processor performs cluster-based edge integrity analytics on the received data, and transmits the results of the analytics via the transceiver. In some examples, the processor receives the digitized sensed data and transmits the data. In particular, the transceiver is coupled to an antenna 116 which can send one or more wireless signals to a hotspot mounted reader/transceiver. For example, the antenna can send one or more Bluetooth signals or other wireless signals in accordance with a protocol and thereby provide a wireless data signal to a hotspot mounted reader.

The core element 110 is coupled to a current breaker 112, which is configured to provide instructions to the edge modules 104a-104c including which edge module(s) 104a-104c to provide power to. In some examples, only one edge module 104a-104c is actively powered on at a time. If, for example the first edge module 104a is powered on, no power is transmitted from the first edge module 104a to the second 104b or third 104c edge modules, and power transmission ends at the first edge module 104a. If the second edge module 104b is powered on, power is transmitted through the first wired connection 140a, through the first edge module 104a to the second wired connection 140b to the second edge module 104b. The first edge module 104a is not powered on, but energy is passed through it to the second edge module 104b, which the third edge module 104c is completely off. In some examples, when power passes through the first edge module 104a, the edge module is in a sleep mode. The network terminator 142 indicates the end of the chain of edge modules.

As shown in FIG. 1, the first wired connection 140a continues through the first edge module 104a to the second wired connection 140b to the second edge module 104b. The second wired connection 140h continues through the second edge module 104b to the third wired connection 140c to the third edge module 104c. The third wired connection 140c continues through the third edge module 104c to the network terminator 142. Thus, a wired connection 140 including first 140a, second 140b, and third 140c wired connections connects the base module 102 to the first 104a, second 104b, and third 104c edge modules in a daisy-chain fashion. Through the wired connection 140, the base module 102 provides power to each of the fins 11H, second 104b, and third 104c edge modules. Similarly, through the wired connection 140, the first 104a, second 104b, and third 104c edge modules transmit data (e.g., sensor data) to the base module 102. In some examples, the wires connection 140 induces a VCC line, and ground line, a RS485-A line, and a RS485-B line.

Each edge module 104a, 104b, 104c includes a core processor 130a, a power control component 132a, and a communication element 134a. Additionally, each edge module 104a, 104b, 104c is connected to a sensor element such as the first sensor element 106a connected to the first edge module 104a. In various examples, the sensor elements are designed to generate sensed data related to corrosion, cracks, torque, strain, strain gauge, or some other parameter of a device on which the sensors are located.

Referring to the first edge module 104a, the core processor 130a receives data from the sensor element 106a. In various implementations, the core processor is configured to perform cluster-based edge-integrity analytics. In particular, the processor is configured to receive sensed data from the first sensor element 106a. In some examples, the processor performs cluster-based edge integrity analytics on the received data, and transmits the results of the analytics to the base module 102 via the communication link 140a. In some examples, the processor receives the sensed data from the first sensor element 106a and transmits the data to the base module 102 via the communication link 140a.

The communication element 134a is coupled to the first communication line 140a and includes a receiver pin (RO), a driver pits (DI), a receiver enable pin (RE), and a driver enable pin (DE). The communication element 134a receives the power input over the communication element 134a which powers the first edge module 104a. When data is being transmitted from the core processor 130a to the base module 102, the driver enable pin is enabled. When power is being received from the base module 102, the receive enable pin is enabled.

The power control component 132a is couplet to the core processor 130a. In various implementations, the power control component 132a switches off the power from the first edge module 104a to the second edge module 104b, which also prevents transmission of power to the third edge module 104c and any other modules further down the daisy chain. In some examples, the core processor 130a provides instructions to the power control component 132a.

The power management unit and the energy storage element are coupled to the core element, which includes a processor and a transceiver. The processor can include a printed circuit board, and the printed circuit board can be a digital printed circuit board. The printed circuit board can include active and passive circuit elements. In some examples, the transceiver is coupled to an antenna. In some examples, the transceiver is a Bluetooth low energy (BLE) transceiver. In various examples, the processor is a single or multi-core processor, an M4-core processor, or some other type of processor.

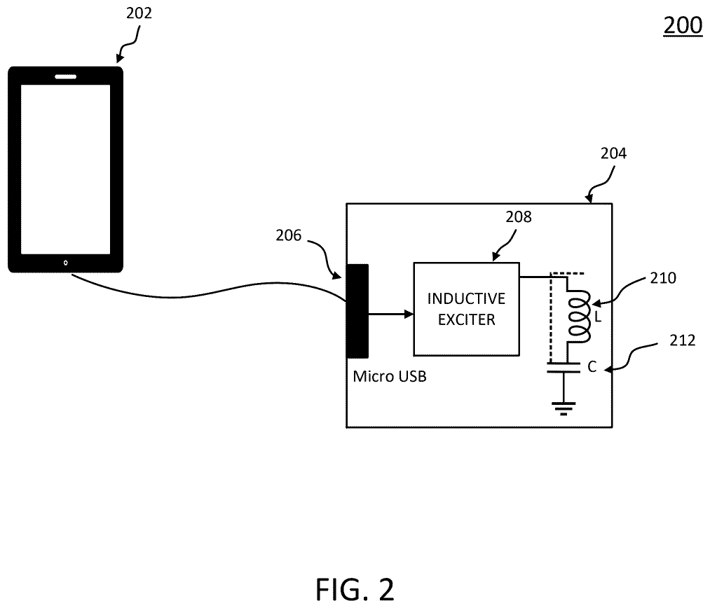

FIG. 2 is a diagram illustrating an exemplary inductive exciter module 204 for charging a WISP device, according to various embodiments of the disclosure. As shown in FIG. 2, the inductive exciter module 204 can draw power from a mobile device 202. In one example, the inductive exciter module 204 is connected to the mobile device 202 via a micro USE connection 206 and draws about 0.5 Amperes at about 5 Volts. In other examples, the inductive exciter module 204 draws power from another source such as a battery pack or outlet. The inductive exciter module 204 includes an inductive exciter 208, which emits inductive energy that can be received by an energy harvester of a WISP device, such as the energy harvester 120 shown in FIG. 1. The inductive exciter 208 is coupled to an inductor 210, which is coupled to a capacitor 212. The other side of the capacitor 212 is connected to ground.

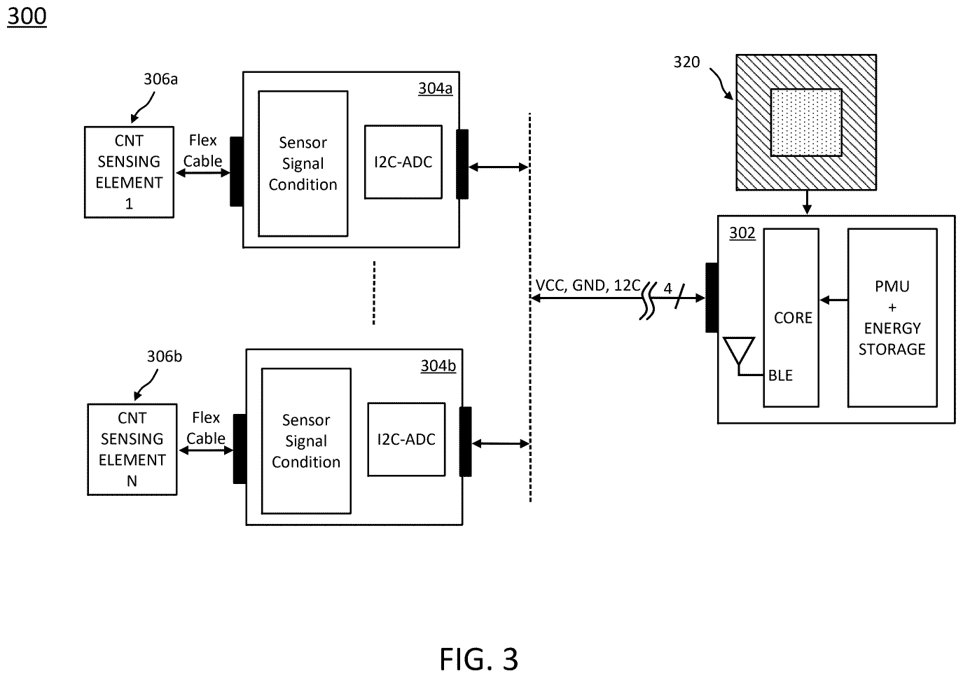

FIG. 3 shows a distributed witness integrity sensing platform (WISP) architecture 300 including a base module 302 connected to multiple edge modules 304a, 304b, according to various embodiments of the disclosure. The base module 302 includes energy storage and a power management unit, a processor, and a transceiver. The base module 302 receives power from an energy harvesting antenna 320.

The multiple edge modules 304a, 304b each include an I2C-ADC and a sensor signal conditioning unit, and are connected to a sensor. The multiple edge modules 304a, 304h are connected to the base module 302 with an I2C connection.

In another aspect, the multiple edge modules 304a, 304b each include a 1-Wire® ADC and a sensor signal conditioning unit, and are connected to a sensor. The multiple edge modules 304a, 304h are connected to the base module 302 with a 1-Wire® connection.

The energy harvesting antenna 320 is configured to receive one or more wireless signals. In some examples, the energy harvesting antenna 320 receives the signals from a hotspot mounted transceiver. In some examples, the wireless signals received at the energy harvesting antenna 320 include radiofrequency energy. The wireless signals may be in accordance with an ISM It+ band and/or a RFID protocol.

The base module 302 includes energy storage and a power management unit, a processor, and a transceiver. The signals received at the energy harvesting antenna 320 are converted energy, which can be stored in the energy storage element in the base module 302. In some examples, the energy can be used to power the base module 302 and the edge modules 304a, 304b, as well as the sensor elements 306a, 306b. The power management unit manages the extracted power. The energy storage element and power management include one or more circuit elements, which can be active or passive. In some examples, the charge storage element includes multiple capacitors. In some examples, the charge storage element includes one or more batteries. In some implementations, the power management unit receives a DC signal as input. The power management unit outputs power to the processor unit and transceiver, as well as to the I2C output line. The power management unit can retrieve energy from the energy storage element to provide power to other WISP elements.

The power management unit and the energy storage element arc coupled to the core element, which includes a processor and a transceiver. The processor can include a printed circuit board, and the printed circuit board can be a digital printed circuit board. The printed circuit board can include active and passive circuit elements. In some examples, the transceiver is coupled to an antenna. In some examples, the transceiver is a Bluetooth low energy (BLE) transceiver. In various examples, the processor is a single or multi-core processor, an M4-core processor, or some other type of processor.

According to various implementations, the processor is configured to perform cluster-based edge-integrity analytics. Specifically, the processor is configured to receive digitized sensed data from the various edge modules 304a-304b via the I2C communication line, as described in greater detail below. In some examples, the processor performs cluster-based edge integrity analytics on the received data, and transmits the results of the analytics via the transceiver. In some examples, the processor receives the digitized sensed data and transmits the data. In particular, the transceiver is coupled to an antenna which can send one or more wireless signals to a hotspot mounted reader/transceiver. For example, the antenna can send one or more Bluetooth signals or other wireless signals in accordance with a protocol and thereby provide a wireless data signal to a hotspot mounted reader.

The base module 302 is connected to multiple edge modules 304a, 3046 via an I2C communication link. In particular, the base module receives data from multiple edge modules 304a. 3046 via a serial data line in the I2C communication link. Although only two edge modules 304a. 304b are shown, it is understood that the distributed WISP architecture can include many edge module. In various examples, a distributed WISP architecture includes five edge modules, eight edge modules, ten edge modules, twelve edge modules, fifteen edge modules, eighteen edge modules, twenty edge modules, or more than twenty edge modules.

The edge modules 304a, 304b each include an I2C analog-to-digital converter (I2C-ADC) and a sensor signal conditioning element. Each edge module 304a, 3046 is connected to a respective sensor 306a, 306b. Sensor data is received at the edge module. In some examples, the sensor signal conditioning element receives sensor data. The sensor signal conditioning elements include one or more resistors and filter sensor output to remove sensor noise, etc. The I2C-ADC converts the filtered analog sensor data from the sensor signal conditioning elements to digital sensed data. The digital sensed data is transmitted to the base module 302 via the I2C communication link.

In various implementations, the sensors are configured to generate sensed data related to corrosion, cracks, torque, strain, strain gauge, or some other parameter of a device on which the sensors are located. In one example, the sensors are positioned in the hull of a helicopter. In another example, the sensors are positioned on the wing of an aircraft. In various examples, the sensors are positioned in a vehicle and designed to sense a parameter related to the structure and/or the structural integrity of the vehicle. In some examples, the sensors are called sensing elements. The sensors can also be used for flight simulations.

In some implementations, a mix of witness integrity sensing elements are used by the distributed WISP architecture to perform hotspot integrity analytics.

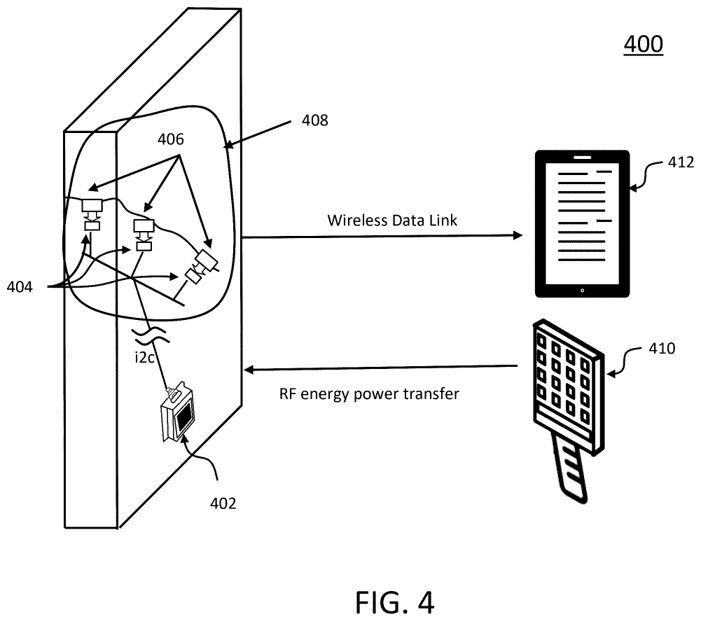

FIG. 4 shows a distributed WISP architecture 400 including an exciter 410, and a reader 412, according to various embodiments. The distributed WISP architecture 400 is shown on the left, including a cluster of sensors 406 and edge modules 404 in an enclosed space 408, connected to a base module 402 via an I2C communication link. While an I2C connection is shown, a 1-Wire® communication link can be used according to another aspect. In the other aspect, data and power are communicated to each of the sensors in the cluster of sensors 406 through the edge modules 404 via the 1-Wire® communication link. The exciter 410 and reader 412 communicate wirelessly with the base module 402. In particular, the exciter 410 can be a hotspot transmitter that transmits wireless signals to the energy harvesting antenna of the base module 402. In some implementations, the hotspot transmitter transmits radio frequency energy signals to the energy harvesting antenna. In various examples, the hotspot transmitter has a non-steer-able energy transmitter, and the hotspot transmitter emits a point-to-point radiofrequency signal to the energy harvesting antenna. The hotspot transmitter includes an antenna which can be, for example, a gain antenna. In some implementations, the hotspot transmitter is an inductive transmitter. In some implementations, the hotspot transmitter wirelessly transmits radiofrequency signals in accordance with a RF identification (RFID) protocol. In some examples, the wireless signals are RF signals in accordance with a worldwide (WW) industrial, scientific, and medical (ISM) RF band. In various examples, the ISM RF band is in the range of 5.725-5.875 gigahertz (GHz), 2.4-2.5 GHZ, or some other worldwide RE band range.

The reader 412 receives data from the base module 402. For example, the reader 412 receives wireless data transmitted from the antenna coupled to the processor in the base module. In some examples, the wireless data is transmitted using a BLE link. In various examples, the reader 412 is a computing device, a computer, a tablet, and/or a smart phone.

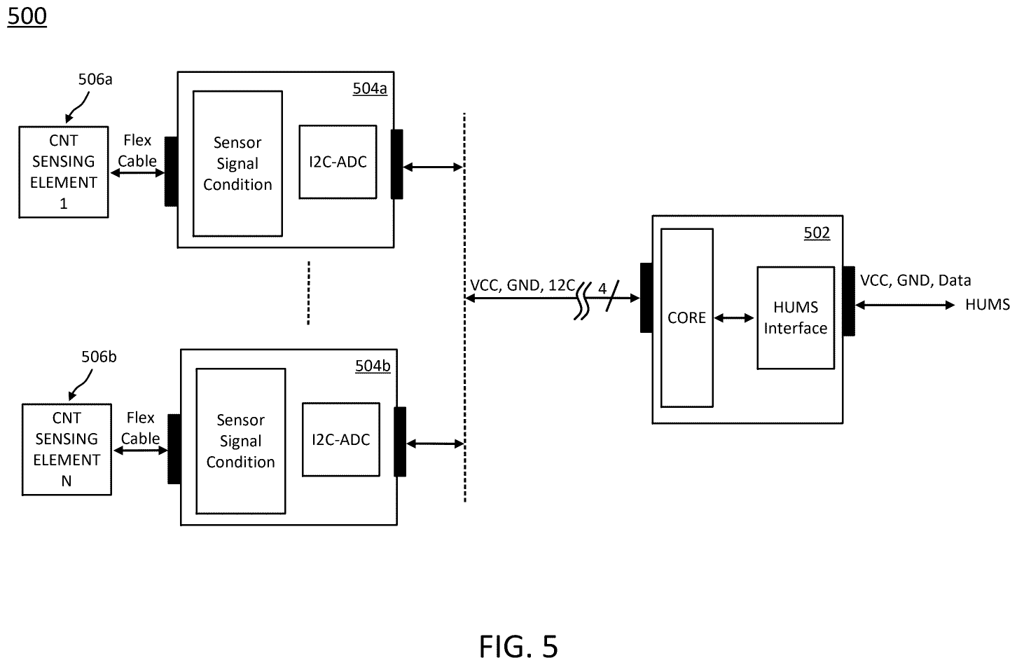

FIG. 5 shows a distributed WISP architecture 500 coupled to a HUMS device, according to various embodiments. A HUMS device is a Health and Usage Monitoring device, and is often used in helicopters and other vehicles. The HUMS device is coupled to the base module 502 of the distributed. WISP architecture 500, and provides power to the base module 502. The HUMS device also receives communications from the base module 502. The base module 502 includes a HUMS interface and a core element including a processor. The HUMS interface in the base module 502 receives energy from the HUMS device and uses the energy to power the base module, and to provide energy to multiple edge modules 504a, 504b.

In some examples, as described above with respect to FIG. 1, the multiple edge modules 504a, 504b are coupled to the base module via a RS485 connection. In other examples, as described above with respect to FIG. 3, the multiple edge modules 504a, 504b are coupled to the base module via an I2C connection. The function of the edge modules 504a, 5046 is the same as the function of the edge modules 304a, 304b of FIG. 3. The edge modules 504a, 504b receive sensed data from sensors 506a, 506b, filter the data, and convert the data to a digital signal, and transmit the digital data back to the base module 502 via the communication link. In some examples, the edge modules 504a, 504b are connected to the base module 502 via a RS485 communication link, as described above with respect to FIG. 1, and the edge modules 504a, 504b transmit data back to the base module 502 via the RS485 communication link. The processor in the base module 502 processes the data, and transmits the processed data to the HUMS device via a wired connection. In some examples, the processor in the base module 502 performs cluster-based edge-integrity analytics on the digital data from the edge modules 504a, 504b.

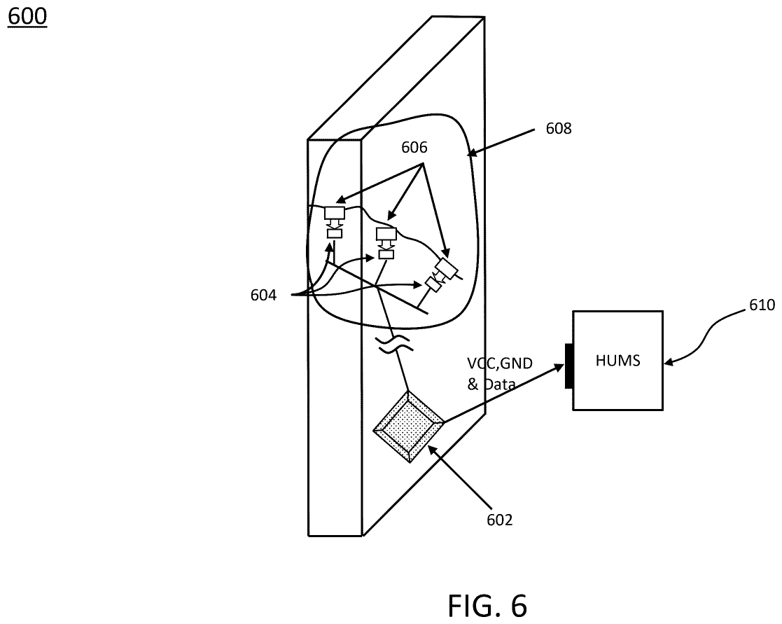

FIG. 6 shows the distributed WTSP architecture 600 described in FIG. 5 with the sensors 606 and edge modules 604 installed in an enclosed space 608, according to various embodiments. The edge modules 604 are connected to a base module 602 via a wired communication link. In some examples, the communication link is a RS485 communication link. In some examples, the communication link is an I2C communication link. The base module 602 includes a HUMS interface and a core element including a processor. The HUMS interface in the base module 602 receives energy from the HUMS device and uses the energy to power the base module, and to provide energy to the edge modules 604a 604b. The HUMS device also receives communications from the base module 602.

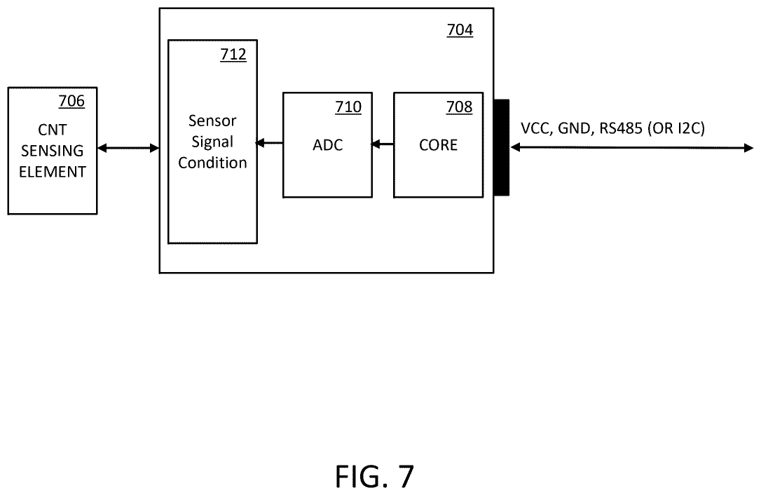

FIG. 7 shows an architecture 700 having edge module 704 and a sensor element 706, according to various embodiments. The edge module 706 shown in FIG. 7 includes a core processor 708, an analog-to-digital converter (ADC) 710, and a sensor signal conditioning element 712. The edge module 704 is connected to a sensor 706. Sensor data is received at the edge module 704. In some examples, the sensor signal conditioning element 712 receives sensor data. The sensor signal conditioning element 712 includes one or more resistors and filters sensor 706 output to remove sensor noise. The ADC 710 converts the filtered analog sensor data from the sensor signal conditioning element 712 to digital sensed data. The processor 708 processes the digital sensed data. The processed digital sensed data is transmitted to a base module via a communication link. In some examples, the communication link is an RS485 communication link. In some examples, the communication link is an I2C communication link. In yet other examples, the communication link is a 1-Wire® communication link. In the other examples, the 1-Wire® communication link can communicate both power and data.

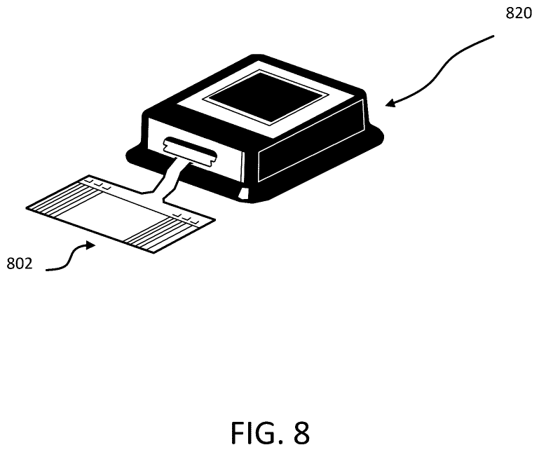

FIG. 8 shows an example 800 of an energy harvesting antenna 820 coupled to a base module 802, according to various embodiments of the disclosure. The energy harvesting antenna 820 receives energy wirelessly from a remote wireless energy transmitter. In some examples, the energy harvesting antenna 820 is an inductive energy harvesting antenna. The energy harvested by the energy harvesting antenna 820 can be stored in an energy storage module such as a battery or a set of capacitors. In some examples, the energy storage module is in the base module 802. In some examples, the energy storage module is coupled to the energy harvesting antenna 820.

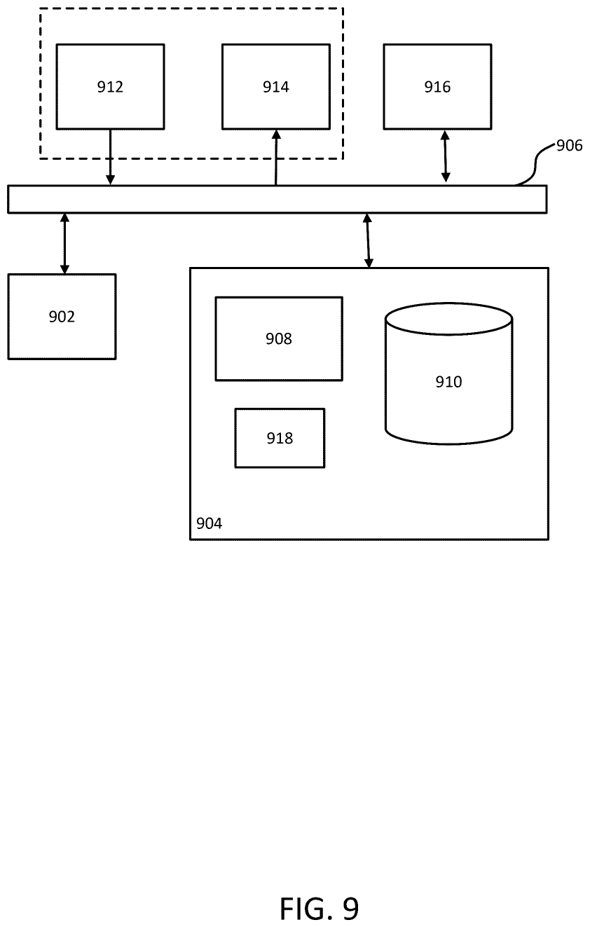

FIG. 9 depicts a block diagram illustrating an exemplary computing system that can be used for multi-sensor witness integrity sensing, according to some embodiments of the disclosure. As shown in FIG. 9, the data processing system 900 may include at least one processor 902 coupled to memory elements 904 through a system bus 906. As such, the data processing system may store program code within memory elements 904. Further, the processor 902 may execute the program code accessed from the memory elements 904 via a system bus 906. In one aspect, the data processing system may be implemented as a computer that is suitable for storing and/or executing program code. It should be appreciated, however, that the data processing system 900 may be implemented in the form of any system including a processor and a memory that is capable of performing the functions described within this specification.

The memory elements 904 may include one or more physical memory devices such as, for example, local memory 908 and one or more bulk storage devices 910. The local memory may refer to random access memory or other non-persistent memory device(s) generally used during actual execution of the program code. A bulk storage device may be implemented as a hard drive or other persistent data storage device. The processing system 900 may a so include one or more cache memories (not shown) that provide temporary storage of at least some program code in order to reduce the number of times program code must be retrieved from the bulk storage device 910 during execution.

Input/output (I/O) devices depicted as an input device 912 and an output device 914 optionally can be coupled to the data processing system. In some examples herein, an input/output device is coupled to a hotspot transceiver. In some examples, input/output devices can be wireless coupled to the data processing system. Examples of input devices may include, but are not limited to, a keyboard, a pointing device such as a mouse, or the like. Examples of output devices may include, but are not limited to, a monitor or a display, speakers, or the like. Input and/or output devices may be coupled to the data processing system either directly or through intervening I/O controllers.

In an embodiment, the input and the output devices may be implemented as a combined input/output device (illustrated in FIG. 9 with a dashed line surrounding the input device 912 and the output device 914). An example of such a combined device is a touch sensitive display, also sometimes referred to as a “touch screen display” or simply “touch screen”. In such an embodiment, input to the device may be provided by a movement of a physical object, such as e.g., a stylus or a linger of a user, on or near the touch screen display.

A network adapter 916 may also be coupled to the data processing system to enable it to become coupled to other systems, computer systems, remote network devices, and/or remote storage devices through intervening private or public networks. The network adapter 916 may comprise a data receiver for receiving data that is transmitted by said systems, devices and/or networks to the data processing system 900, and a data transmitter for transmitting data from the data processing system 900 to said systems, devices and/or networks. Modems, cable moderns, and Ethernet cards are examples of different types of network adapter that may be used with the data processing system 900.

As pictured in FIG. 9, the memory elements 904 may store an application 918. In various embodiments, the application 918 may be stored in the local memory 908, the one or more bulk storage devices 910, or apart from the local memory and the bulk storage devices. In some examples, the application 918 can include an application for cluster-based integrity analytics. It should be appreciated that the data processing system 900 may further execute an operating system (not shown in 11G. 9) that can facilitate execution of the application 918. The application 918, being implemented in the form of executable program code, can be executed by the data processing system 900, e.g., by the processor 902. Responsive to executing the application, the data processing system 900 may be configured to perform one or more operations or method steps described herein.

In another aspect, the data processing system 900 may represent a client data processing system. In that case, the application 918 may represent a client application that, when executed, configures the data processing system 900 to perform the various functions described herein with reference to a “client”. Examples of a client can include, but are not limited to, a personal computer, a portable computer, a mobile phone, or the like.

Persons skilled in the art will recognize that while the elements 902-918 are shown in FIG. 9 as separate elements, in other embodiments their functionality could be implemented in lesser number of individual elements or distributed over a larger number of components.

Various embodiments of the invention may be implemented as a program product for use with a computer system, where the program(s) of the program product define functions of the embodiments (including the methods described herein). In one embodiment, the program(s) can be contained on a variety of non-transitory computer-read able storage media, where, as used herein, the expression “non-transitory computer readable storage media” comprises all computer-readable media, with the sole exception being a transitory, propagating signal. In another embodiment, the program(s) can be container on a variety of transitory computer-readable storage media. Illustrative computer-readable storage media include, but are not limited to: (i) non-writable storage media (e.g., read-only memory devices within a computer such as CD-ROM disks readable by a CD-ROM drive, ROM chips or any type of solid-state non-volatile semiconductor memory) on which information is permanently stored; and (ii) writable storage media (e.g., flash memory, floppy disks within a diskette drive or hard-disk drive or any type of solid-state random-access semiconductor memory) on which alterable information is stored. The computer program may be run on the processor 902 described herein.

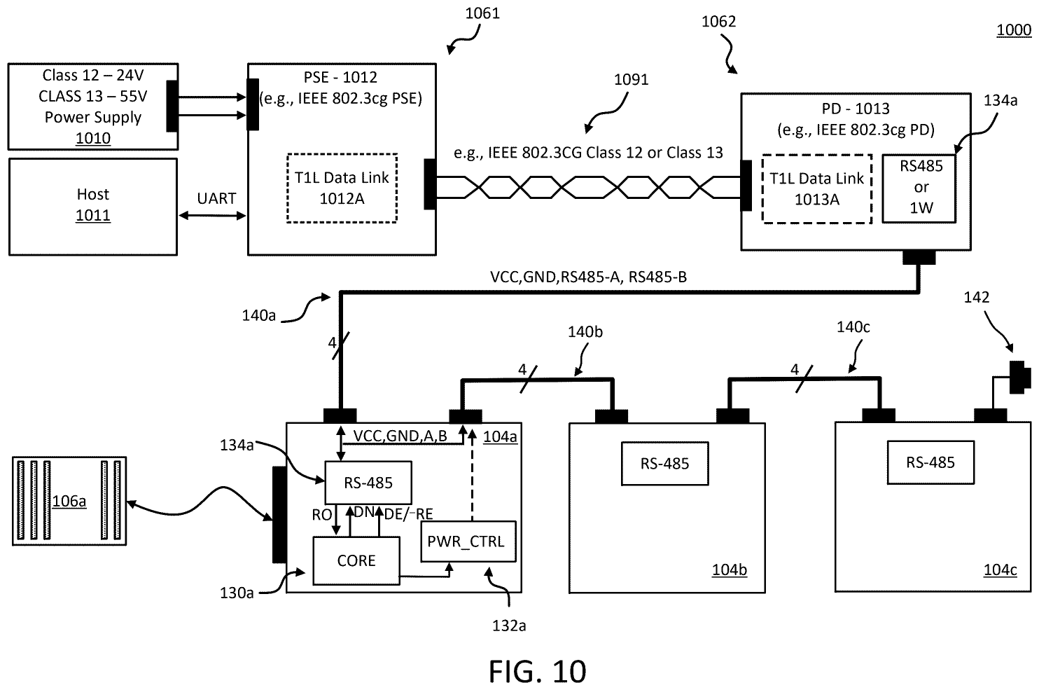

FIG. 10 shows another exemplary distributed witness integrity sensing platform (WISP) architecture 1000, in accordance with an example aspect.

In an aspect, elements of WIPS such as PSE 1012 and PD 1013 are compliant with one or more of the Institute of Electrical and Electronic Engineers (IEEE) 802.3bu and IEEE 802.3cg standards. IEEE 802.3bu and IEEE 802.3cg are both standards for powering and connecting devices over a single pair of conductors. In other aspects of the present disclosure, compliance with other standards and/or amendments may be achieved from the platform configurations described herein.

IEEE 802.3bu is also known as “Power over Data Line” (PoDL). IEEE 802.3cg is also known as “Single-pair Power over Internet” (SPoE), and “Single Pair Ethernet” (SPE) in short. The preceding terms are often all interchanged. Moreover, IEEE standard 802.3cg is often referred to as “10BASE-T1L” or “T1L” in short due to its 10 Mbps data rate over a single twisted pair. IEEE 802.3bu supports 100BASE-T1 and 1000BASE-T1 Ethernet. As noted above, IEEE 802.3cg supports 10Base-T1L. IEEE 802.3bu defines 10 power classes that can send 0.566 to 65.3 W of power across the pair. IEEE 802.3cg adds 5 power classes to the 10 power classes of IEEE 802bu.

WISP 1000 mainly differs from WISP 100 of FIG. 1 with respect to using a wired power solution (a power supply) in place of a low-range wireless power solution (an energy harvester 120 coupled to an antenna 116) to enable farther signal distribution due to the limitations of the low range wireless power solution. In contrast to WISP 100 of FIG. 1, WISP 1000 allows for 10-Mbps full-duplex communications up to a distance of 1,000 meters between the PSE 1012 and PD 1013 through a single pair of twisted wires and not tens of meters like the short-range wireless approach of WISP 100 of FIG. 1.

For example, in an aspect, WISP 1000 differs from WISP 100 of FIG. 1 in lacking the energy harvester 120 and corresponding supporting energy harvesting elements (e.g., antenna 116) of FIG. 1. In contrast, power is supplied in WISP 1000 using a power supply 1010.

In an aspect, an Institute of Electrical and Electronic Engineers (IEEE) 802.3bu or cg class such as, e.g., IEEE 802.3cg class 12, may be used by power supply 1010 to supply 24 volts. In another aspect, an IEEE 802.3cg class 13, 55 volt power supply may be used for the power supply 1010. Different power classes within the standard allow for varying power delivery levels depending on the application needs. In other aspects, other power supplies corresponding to other standards, classes, and voltages may be used.

WISP 1000 differs from WISP 100 of FIG. 1 in replacing the power management unit 108 of FIG. 1 by power sourcing equipment (PSE) 1012. PSE 1012 is configured to provide input power to a Powered Device (PD) 1013 described below. In an aspect, the PSE 1012 may perform functions such as signal processing on input power provided to the PSE 1012 from power supply 1010 in preparation for use by PD 1013. Such signal processing may include conversion from analog to digital, noise suppression, and so forth. PSE 1012 provides a direct current (DC) voltage on the Ethernet cable, which is then extracted by PD 1013 at the receiving end. PSE 1012 is configured to manage power delivery to PD 1013, including protections against overcurrent situations and power surges.

The term “power sourcing equipment” (PSE) is used to refer to the entity that injects power into the Ethernet cable 1091, and the term “powered device” (PD) refers to the device that extracts the power from the Ethernet cable 1091 and consumes power including by distributing the power to the edge modules 104a, 104b, 104c. Typically, PSE 1012 is an Ethernet switch, but PSE 1012 can also be special power injectors that are distinct from the switch.

In an aspect, PSE 1012 is a Power over Data Line (PoDL) PSE. The functionality of a PoDL PSE is currently defined within the IEEE 802.3bu standard, which outlines how to implement power delivery over single-pair Ethernet. That is, in an aspect, PSE 1012 is compliant with the following standard: IEEE standard 802.3bu. IEEE standard 802.3bu (PoDL) is specified for 100 and 1000 BASE-T1 Ethernet. The term “PoDL PSE” specifically denotes PSEs operating with single balanced twisted-pair PHYs, as per Clause 104 of IEEE 802.3bu.

IEEE 802.3 specifies that a detection phase and classification phase are required. During the detection phase, PSE 1012 senses if a compliant device (a compliant PD 1013) is connected. If so, then the classification phase involves PSE 1012 reading out from PD 1013 which power classes are supported by PD 1013. If PSE 1012 and PD 1013 support the same class(es), then PSE 1012 turns on power so PD 1013 can receive the power.

The IEEE 802.3bu standard defined 4 types of PSEs Type A, Type B, Type C, and Type D. The IEEE 802.3bu standard also defines 10 different power classes for PDs and PSEs including 12-V, 24-V and 48-V unregulated and regulated PSE classes. The IEEE 802.3cg standard extended the preceding characteristics of the IEEE 802.3bu standard by introducing a type E PSE and adding 30 V and 58 V classes bringing the total to 15 different compliant classes. Some of the functions of PSE 1012 include: (a) to search Ethernet link segment 1091 for PD 1013; (b) to supply power to PD 1013 through Ethernet link segment 1091; (c) to monitor the power applied to Ethernet link segment 1091; and (d) to remove the full operating voltage when no longer required, or when a short-circuit or other fault is detected.

In an aspect, PSE 1012 is a Single Pair Ethernet (SPE) PSE. The functionality of a SPE PSE is currently defined within the Institute of Electrical and Electronic Engineers (IEEE) 802.3cg standard, which outlines how to implement power delivery over single-pair Ethernet. That is, in an aspect, PSE 1012 is compliant with the following standard: IEEE standard 802.3cg.

In further describing FIG. 10, a 10 BASE-T1L configuration will be described. Hence, hereafter, PSE 1012 is considered a SPE PSE. Moreover, data links 1012A and 1013a may be considered T1L data links.

WISP 1000 differs from WISP 100 of FIG. 1 in using powered device (PD) 1013. In the context of the IEEE 802.3 standard, a “powered device” (PD) refers to any network device that receives power directly over an Ethernet cable using Power over Ethernet (POE) technology, meaning the network device draws power from the network connection instead of a separate power adapter. Here, PD 1013 receives power directly from Ethernet link segment 1091, which is connected to PSE 1012. PD 1013 also provides power to, and receives data from, edge modules 104a, 104b, 104c that include and/or otherwise communicate with sensors 106a for collecting sensor data. In an aspect, the received data by PD 1013 from edge modules 104a, 104b, 104c, includes sensor data. In an aspect, PD 1013 also transmits data to the edge modules 104a, 104b, 104c. In an aspect, the transmitted data from PD 1013 to edge modules 104a, 104b, 104c includes configuration instructions for edge modules 104a, 104b, 104c and/or sensors 106a.

In an aspect, PD 1013 device negotiates its power requirements with PSE 1012 through the standard protocol. In an aspect, PSE 1012, measures the voltage across a Zener diode on the PD side. Classification is also implemented by considering PD 1013 as a constant current sink in which the current defines the power class.

In an aspect, PD 1013 decouples power from the power and data path on the Ethernet link segment 1091 in a safe manner while allowing the data to pass through to the edge modules 104a, 104b, 104c and with no impact on the signal integrity. The PD 1013 includes a RS485 module for communicating with edge modules 104a, 104b, 104c. In addition, IEEE 802.3cg specifies that PD 1012 can receive power in two modes when its power input pins are swapped. Each of datalink 1012A in PSE 1012 and datalink 1013A in PD 1013 provide a respective unified interface for both data and the power required to process this data over a single balanced twisted-pair Ethernet connection. In an aspect, each of datalink 1012A and datalink 1013A include a respective physical layer transceiver (PHY) for transmitting and receiving signals (power and data) over Ethernet link segment 1091. In an aspect, datalink 1012A and datalink 1013A are PoDL data links in accordance with IEEE 802.3bu. In an aspect, datalink 1012A and datalink 1013A are T1A datalinks in accordance with IEEE 802.3cg. Accordingly, as T1L datalinks, datalink 1012A and datalink 1013A are capable of supporting data rates up to 10 Mbps carried over data segment 1091.

WISP 1000 further differs from WISP 100 of FIG. 1 in replacing the processor 110 with a host 1011. In an aspect, host 1011 receives sensor data from sensors in edge modules 104a, 104b, 104c, aggregates the sensor data, processes the aggregated sensor data, and generates response data for sending to the sensors 106a or other equipment 1078. For example, in an aspect, based on sensed deflection of a structural member as indicated by the sensor data, response data from host 1011 may include instructions for initiating and/or otherwise controlling an alert system for providing an alert of the deflection to a remote location. In this way, corrective action can be dispatched as needed. In another aspect, signs directing traffic to an alternate route may be initiated in the case of current path (e.g., using a bridge) is determined to be unsafe. In an aspect, a table or other mapping construct may be used by host 1011 to correlate sensor values from sensors 106a with particular and different detectable conditions and corresponding courses of action.

According to various implementations, host 1011 is configured to perform cluster-based edge-integrity analytics. Specifically, one or more processors of host 1011 are configured to receive digitized sensed data from the various edge modules 104a-104c via the communication line 140 (including lines 140a, 140b, 140c), as described in greater detail below. In some examples, the processor performs cluster-based edge integrity analytics on the received data, and transmits the results of the analytics via a transceiver (not shown). In some examples, the processor receives the digitized sensed data and transmits the data. In particular, the transceiver is coupled to an antenna which can send one or more wireless signals to a hotspot mounted reader/transceiver. For example, the antenna can send one or more Bluetooth signals or other wireless signals in accordance with a protocol and thereby provide a wireless data signal to a hotspot mounted reader.

In an aspect, host 1011 is configured to provide instructions to the edge modules 104a-104c including which edge module(s) 104a-104c to provide power to. In some examples, only one edge module 104a-104c is actively powered on at a time. If, for example the first edge module 104a is powered on, no power is transmitted from the first edge module 104a to the second 104b or third 104c edge modules, and power transmission ends at the first edge module 104a. If the second edge module 104b is powered on, power is transmitted through the first wired connection 140a, through the first edge module 104a to the second wired connection 140b to the second edge module 104b. The first edge module 104a is not powered on, but energy is passed through it to the second edge module 104b, which the third edge module 104c is completely off. In some examples, when power passes through the first edge module 104a, the edge module is in a sleep mode. The network terminator 142 indicates the end of the chain of edge modules.

In an aspect, host 1011 is connected to PSE 1012 via a Universal Asynchronous Receiver/Transmitter (UART), a hardware protocol that sends and receives data over two wires. UART is a serial communication method that transmits data as a series of bits, one at a time. UART converts parallel data from a device into a serial stream, then sends it to a receiving device that converts it back to parallel. UART uses start and stop bits to indicate the beginning and end of a data packet. Asynchronous means no shared clock, so for UART to work, the same bit or baud rate must be configured on both sides of the connection, namely at host 1011 and at PSE 1012.

In an aspect, host 1011 runs artificial intelligence algorithms in making decisions (deciding courses of action) based on the sensor data. In an aspect, host 1011 employs one or more learning algorithms that learn a proper course of action over time, e.g., using self-correction to minimize an error function. In this way, repeated occurrences of a particular type can be met with a consistent or even improving response as compared to past responses.

WISP 1000 involves 2 lines, also referred to herein as Ethernet link segment 1091, commencing from datalink 1012A in PSE 1012 and terminating at corresponding datalink 1013A in PD 1013.

In an aspect, datalink 1012A in PSE 1012 and datalink 1013A in PD 1013 are components for coupling PSE 1012 to a first side of wired link segment 1091 and PD 1013 to a second side of wired link segment 1013, to allow power and data to be sent from PSE 1012 to PD 1013 and for data to be sent from PD 1013 to PSE 1012. In an aspect, datalink 1012A and datalink 1013A are capable of supporting communications in accordance with IEEE 802.3bu and/or IEEE 802cg. In an aspect, the datalinks 1012A are used to send power from the PSE 1012 to the PD 1013 for distribution to the edge modules 104a, 104b, 104c, and ultimately the sensors 106a that are connected to, or integrated with, the edge modules 104a, 104b, 104c.

In an aspect, the 2 lines of wired link segment 1091 are comprised in a 2-wire twisted cable. In an aspect, each of the 2 lines provide Power over Data Line (PoDL) in accordance with IEEE 802.3bu or Single Pair Ethernet (SPE) in accordance with IEEE 802.3cg, depending upon the implementation. That is, the Ethernet link segment 1091 connecting PSE 1012 to PD 1013 is a standard Ethernet cable, which simultaneously transmits both data and electrical power to PD 1013 from PSE 1013; essentially acting as the “link” between the two devices (PSE 1012 and PD 1013). PSE 1012 supplies power to Ethernet link segment 1091, and PD 1013 draws power from Ethernet link segment 1013.

The edge modules 104, 104b, 104c and corresponding sensors 106a operate as described hereinabove with respect to FIG. 1. For example, in an aspect, each of edge modules 104a, 104b, 104c is coupled connected to a respective sensor 106a. PSE 1012 is connected to a control side 1061 of link segment 1091, and PD 1013 is connected to a controlled side 1062 of link segment 1091. The link segment 1091 separates the control side 1061 from the controlled side 1062. PSE 1012 is configured to selectively power respective sensors 106a through link segment 1091, PD 1013, and selective ones of the edge modules 104a, 104b, 104c. A daisy-chain communication link connects host 1011 to each of the edge modules 104a, 104b, 104c in series. Each of the edge modules 104a, 104b, 104c transmits a respective data signal to host 1011. The daisy-chain communication link ends at a network terminator 1051.

For example, as shown in FIG. 1 and FIG. 10, the first wired connection 140a continues through the first edge module 104a to the second wired connection 140b to the second edge module 104b. The second wired connection 140h continues through the second edge module 104b to the third wired connection 140c to the third edge module 104c. The third wired connection 140c continues through the third edge module 104c to the network terminator 142. Thus, a wired connection 140 including first 140a, second 140b, and third 140c wired connections connects the host 1011 to the first 104a, second 104b, and third 104c edge modules in a daisy-chain fashion.

The power control component 132a is coupled to the core processor 130a. In various implementations, the power control component 132a switches off the power from the first edge module 104a to the second edge module 104b, which also prevents transmission of power to the third edge module 104c and any other modules further down the daisy chain. In some examples, the core processor 130a provides instructions to the power control component 132a.

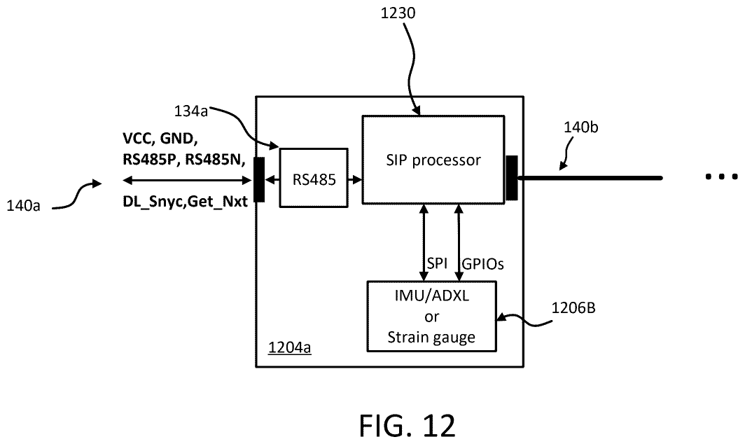

While shown separate from, but connected to edge modules 104a, 104, 104c in the aspect of FIG. 10, in another aspect the sensors 106a are integrated with the edge modules 104a, 104b, 104c to form integrated units. In such a case, Serial Protocol Interface (SPI) and/or General Purpose Input Output (GPIO) may be used for intra-device communication between a core 130a of an edge module 104a and a sensor 106. FIG. 12 described below shows an edge module 1204a and integrated sensor 1206a.

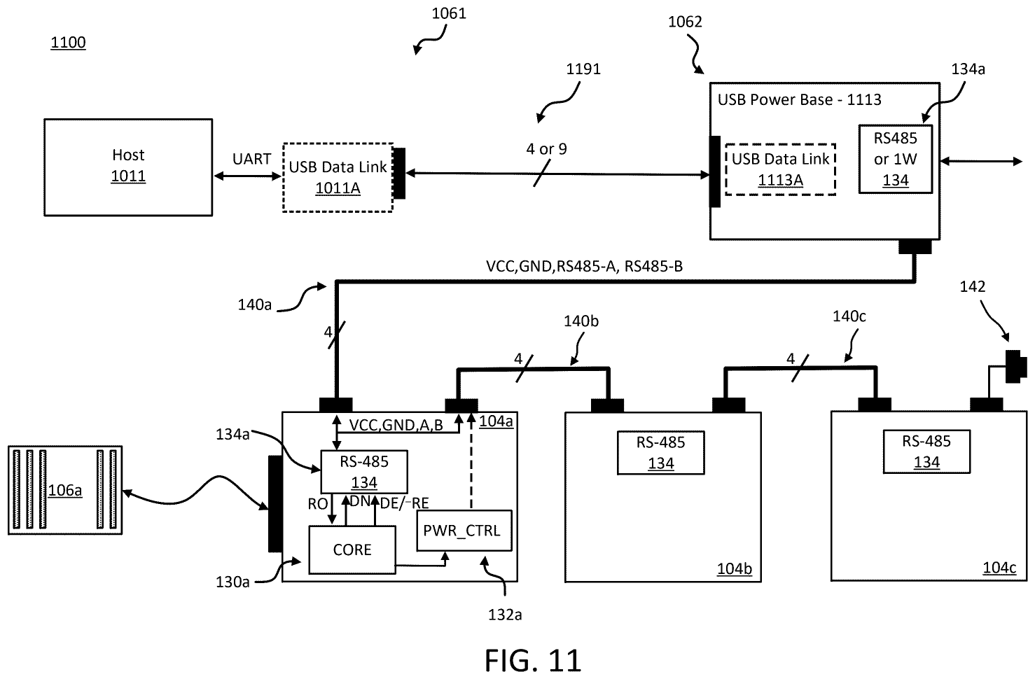

FIG. 11 shows yet another exemplary distributed witness integrity sensing platform (WISP) architecture 1100, in accordance with an example aspect.

WISP 1100 mainly differs from WISP 1000 of FIG. 10 with respect to using Universal Serial Bus (USB) in place of PoDL or SPE. To that end, a single USB cable, comprised of multiple wires, is used in WISP 1100, as compared to the single wire pair used in WISP 1000 of FIG. 10. The single USB cable forms, and is hereinafter referred to as, USB link segment 1191.

USB is an industry standard, developed by USB Implementers Forum (USB-IF), that allows data exchange and delivery of power between many types of electronics. The USB standard specifies the USB architecture, in particular its physical interface, and communication protocols for data transfer and power delivery to and from hosts, such as, e.g., servers, personal computers, and so forth, to and from peripheral devices such as, e.g., sensors 106a.

In an aspect, USB 2.0 is used in WISP 1100. The USB 2.0 standard defines a cable comprised of four wires and pins. USB 2.0 is half-duplex, arbitrated by host 1011.

In an aspect, a USB 3.X standard such as USB 3.0 is used in WISP 1100. The USB 3.0 standard defined a new architecture and protocol named SuperSpeed (also referred to as “SuperSpeed USB” or “SS” in short), which provides full-duplex data transfers that physically required five additional wires and pins, while preserving the USB 2.0 architecture and protocols and therefore keeping the original four wires and pins for USB 2.0 backward-compatibility resulting in 9 wires (with 9 or 10 pins at connector interfaces; ID-pin is not wired) in total. Thus, in an aspect, either USB 2.0 or USB 3.0 may be implemented on a single USB 3.0 cable (implemented in FIG. 11 as link segment 1191). USB 3.0 can provide data transfer rates up to 5 Gbps. In an aspect, USB 3.2 is used for transfer rates up to 10 or 20 Gbps.

In an aspect, a USB 4.X standard such as USB 4 or USB 4 2.0 is used in WISP 1100. USB 4 is based on the Thunderbolt 3 protocol. USB 4 supports 40 Gbps throughput. USB 4 is compatible with Thunderbolt 3 and backward compatible with USB 3.2 and USB 2.0. Features of USB 4 include: its own protocol and error correction; a USB 4 host router that manages bandwidth needs; multiple tiers or layers for complex device trees; a USB 4 device router that routes tunneled traffic to the appropriate downstream ports. The USB 4 architecture defines a method to share a single high-speed link with multiple end device types dynamically that best serves the transfer of data by type and application. USB 4 2.0 builds upon USB 4 in providing support for up to 120 Gbps throughput.

Regarding cabling in WISP 1100, USB 2.0 provides for a maximum cable length of 5 meters (16 ft 5 in) for devices running at high speed (480 Mbit/s). In contrast, USB 3.0 does not directly specify a maximum cable length, requiring only that all cables meet an electrical specification: for copper cabling with 26 AWG wires, the maximum practical length is 3 meters (9 ft 10 in). Aspects of the present disclosure may apply to the described USB versions as well as those currently being developed and yet to be developed. The present disclosure is applicable to the use of a serial data protocol involving one or more twisted wire pairs to convey both power and data.

USB-C refers to the shape of a 24 pin connector. A USB-C connector may support, e.g., USB 3.1 (fast data transfer) or 2.0 (slower data transfer). Not all USB-C ports can handle all of power, audio, video, and data. Some USB-C ports can only charge, or only transfer data, and so on. However, a “full-functioned” (also referred to as “full-featured”) USB-C port can handle power, audio, video, and data, and can transmit them all at the same time.

Regarding power in WISP 1100 for a host providing power to devices, USB has a concept of the “unit load.” According to the concept of the unit load, any device (here, USB power base 1113) may draw power of one unit, and devices (again, USB power base 1113) may request more power in these discrete steps. It is not required that host 1011 provide requested power, and a device (again, USB power base 1113) may not draw more power than negotiated (with host 1011).

Devices that draw no more than one unit are considered to be “low-power” devices. All devices must act as low-power devices when starting out as unconfigured. For USB 2.0, a unit load is 100 mA (or 500 mW). USB 3.0 defines a unit load as 150 mA (750 mW). Full-featured USB-C can support low-power devices with a unit load of 250 mA (or 1250 mW).

Devices that draw more than one unit are considered to be “high-power” devices. USB 2.0 allows a host or hub to provide up to 2.5 W to each device, in five discrete steps of 100 mA, and SuperSpeed devices (USB 3.0 and up) allows a host or a hub to provide up to 4.5 W in six steps of 150 mA. USB-C supports high-power devices with up to 7.5 W, in six steps of 250 mA. Full-featured USB-C can support up to 15 W.

Regarding signaling in WISP 1100, USB 2.0 uses two wires for power (VBUS and GND), and two for differential serial data signals. USB 3.0 provides two additional differential pairs, providing full-duplex data transfers. Thus, USB signals are transmitted using differential signaling on twisted-pair data wires. USB 2.0 defines a single pair in half-duplex (HDx). USB 3.0 and later specifications define one dedicated pair for USB 2.0 compatibility and two or four pairs for data transfer: two pairs in full-duplex for single lane variants require at least SuperSpeed (SS) connectors; four pairs in full-duplex for two lane (×2) variants require USB-C connectors. USB 4 Gen 4 requires the use of all four wire pairs, but allow for asymmetrical wire pairs configuration. Asymmetrical wire pairs configured refers to using one lane for the upstream data and the other three lanes for the downstream data, or vice-versa. USB 4 Gen 4 uses pulse amplitude modulation.

In WISP 1100, PSE 1012 of WISP 1000 of FIG. 10 is omitted. Instead, USB link segment 1191 (USB cable) is connected directly to a USB interface or datalink 11011A of host 1011 on one end and to a USB interface or datalink 1113A of a USB power base 1113 on the other end. The USB power base 1113 essentially replaces the PD 1013 of WISP 1000 of FIG. 10. In an aspect, USB interfaces 1011A and 1113A are self-configuring, eliminating the need for the user to adjust the devices' settings for speed or data format, or configure interrupts, input/output addresses, or direct memory access channels.

USB power base 1113 further includes an RS485 or 1-Wire® interface 134 for interfacing with an RS485 or 1-Wire® interface of edge module 104a. Edge modules 104a, 104b, and 104c (and corresponding sensors 106a) are described in detail hereinabove.

In an aspect, datalink 1111A on power side 1161 and datalink 1113A USB power base 1113 are components for coupling host 1011 to a first side of wired link segment 1091 and PD 1013 to a second side of wired link segment 1013, to allow power and data to be sent from PSE 1012 to PD 1013 and for data to be sent from PD 1013 to PSE 1012 (and then forwarded to host 1011). In an aspect, datalink 1012A and datalink 1013A are capable of supporting communications in accordance with a USB standard. In an aspect, the datalinks 1012A are used to send power and data from the PSE 1012 to the PD 1013 for distribution to the edge modules 104a, 104b, 104c, and ultimately the sensors 106a that are connected to, or integrated with, the edge modules 104a, 104b, 104c.

The edge modules 104, 104b, 104c and corresponding sensors 106a operate as described hereinabove with respect to at least FIG. 1 and FIG. 10. For example, in an aspect, each of edge modules 104a, 104b, 104c is coupled connected to a respective sensor 106a. Host 1011 is connected to a control side 1161 of link segment 1191, and USB power base 1113 is connected to a controlled side 1162 of link segment 1191. The link segment 1191 separates the control side 1161 from the controlled side 1162. Host 1011 is configured to selectively power respective sensors 106a through link segment 1191, USB power base 1113, and selective ones of the edge modules 104a, 104b, 104c. A daisy-chain communication link connects host 1011 to each of the edge modules 104a, 104b, 104c in series. Each of the edge modules 104a, 104b, 104c transmits a respective data signal to host 1011. The daisy-chain communication link ends at a network terminator 1051.

For example, as shown in at least FIG. 1, FIG. 10, and FIG. 11, the first wired connection 140a continues through the first edge module 104a to the second wired connection 140b to the second edge module 104b. The second wired connection 140h continues through the second edge module 104b to the third wired connection 140c to the third edge module 104c. The third wired connection 140c continues through the third edge module 104c to the network terminator 142. Thus, a wired connection 140 including first 140a, second 140b, and third 140c wired connections connects the USB power base 1113 to the first 104a, second 104b, and third 104c edge modules in a daisy-chain fashion.

While shown separate from, but connected to edge modules 104a, 104, 104c in the aspect of FIG. 11, in another aspect the sensors 106a are integrated with the edge modules 104a, 104b, 104c to form integrated units. In such a case, Serial Protocol Interface (SPI) and/or General Purpose Input Output (GPIO) may be used for intra-device communication between a core 130a of an edge module 104a and a sensor 106.

FIG. 12 described below shows an edge module 1204a and integrated sensor 1206a, in accordance with an example aspect.

Edge module 1204a includes a communication module (e.g., a RS485 module) 134, an edge System-In-Package (SIP) or “SIP” 1230 in short, and an integrated sensor 1206a.

The communication module (e.g., RS485 module) 134 is as described hereinabove. In short, RS485 is a standard defining the electrical characteristics of serial lines for use in serial communications systems. RS485 is known for being able to be used effectively over long distances and in electrically noisy environments. Due to this, the RS485 is used commonly as a protocol for industrial applications. While RS485 is used with respect to various aspects described herein, in other aspects, other serial data communication standards and/or serial data communication techniques may also be used. That is, the communications from the power distributing element (e.g., the PD 1013 of WISP 1000 or the USB power base 1113 of WISP 1100) to a first edge module, and from the first edge module 1204a serially to subsequent edge modules (not shown, but see, e.g., FIG. 1, FIG. 10, and FIG. 11) in a daisy chain configuration terminated by a network terminator, shown in at least FIG. 1, FIG. 10, and FIG. 11, may use RS485 or another serial communication standard or technique and corresponding hardware capable of being configured in a daisy-chain configuration and terminated by a terminator.

In another implementation, host 1011 is connected to multiple edge modules using a wired I2C connection, and each edge module includes an I2C-ADC, a sensor signal conditioning element, and a sensing element. In particular, using an I2C configuration, two wires can be used to connect the base module to any number of sensors. VCC and ground are also sent across the bus to power the edge modules. I2C (or inter-integrated circuit bus) is a communication protocol having two wires, including a serial data line for sending and receiving data between a master and slave.

The communication element 134a is coupled to the first communication line 140a and includes a receiver pin (RO), a driver pits (DI), a receiver enable pin (RE), and a driver enable pin (DE). The communication element 134a receives the power input over the communication element 134a which powers the first edge module 104a. When data is being transmitted from the core processor 130a to the host 1011, the driver enable pin is enabled. When data is being received from the host 1011, the receive enable pin is enabled.

According to various implementations, splitting up the WISP system into multiple modules (a host 1011 and an edge module 1204a) and connecting the modules 1011, 1204a using a wired connection (such as RS485 or I2C or a 1-Wire® connection, or so forth) allows multiple sensors to be placed in an enclosed (and generally inaccessible) location. The senor data can be transmitted via the wired connection to host 1011. Additionally, the use of the multiple module system with wired connection, as provided herein, allows the sensors to be positioned many meters away from the base module In various examples, the sensors can be positioned five, ten, fifteen, twenty, fifty, one hundred, two hundred, three hundred, four hundred, five hundred, six hundred, seven hundred, eight hundred, nine hundred, ten hundred or more than ten hundred meters away from the base module.

SIP 1230 is a component that includes multiple chips in a single package. In an aspect, SIP 1230 includes one or more processors and one or more memories. In an aspect not shown, SIP 1230 may integrate and/or otherwise include RS485 module 134, an IC2 module, and/or other serial communication module such as 1-Wire® serial communication module that uses a different serial communication standard or technique. SIP 1230 is configured to receive sensor data from integrated sensor 1206A and optionally process the data to, e.g., filter the data for a particular bandwidth, mitigate noise, standardize the data, make the data suitable for transmission (e.g., packetize the data) over RS485 module 134 (or an I2C module or 1-Wire® module), and so forth. In various aspects involving longer distances, RS485 or 1-Wire® are used. For various aspects involving higher data rates, I2C is preferable over 1-Wire®.

SIP 1230, also referred to as edge SIP 1230, includes: a core; an edge ADC with analog to sensor front end analog circuitry; a 1-Wire® communication data link; and the ability to power the next sensor in the daisy chain. The core of each SIP 1230 controls the active mode and power down mode, and enables switching to the next node between the selected sensing element and an end of the daisy-chain from a not-active-mode to an active-mode.

The integrated sensor 1206a functions similarly to (non-integrated) sensor 106a with regarding to sensing and only differs in regard to how information is communicated from the sensor to the corresponding edge module due to their integration. In an aspect, the integrated sensor 1206a communicates with SIP 1230 of the edge module 1204a using SPI and/or GPIO. The integrated sensor 1206a may include one or more of an acceleration sensor, a deflection sensor, a strain gauge, and so forth. In various examples, sensors 106a and 1206a are designed to generate sensed data related to corrosion, cracks, torque, strain, strain gauge, or some other parameter of a device or object (such as a road, a bridge, and so forth) on which sensors 106a and 1206a are located.

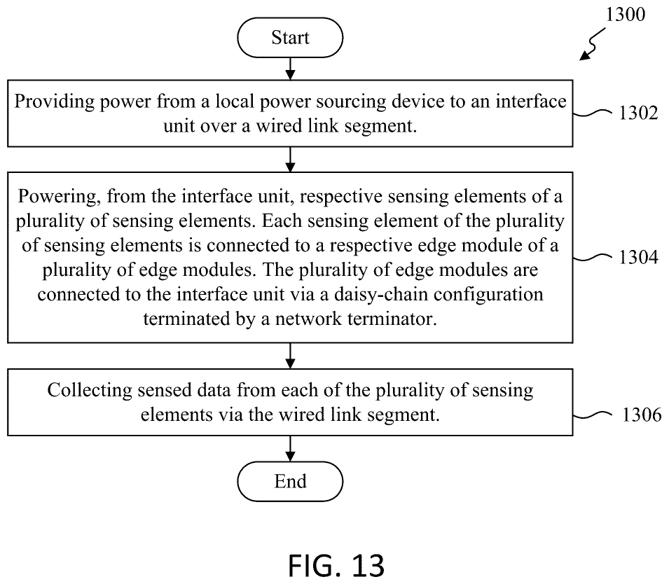

FIG. 13 shows a flowchart of a method 1300 for witness integrity sensing, in accordance with an example aspect. In the flowchart of FIG. 13 and those that follow, solid lines are used to show essentially blocks, and dashed or dashed-dotted lines are used to show optional blocks.

Referring to FIGS. 10-13, at block 1302, method 1300 includes providing power from a local power sourcing device (e.g., PSE 1012, host 1011) to an interface unit (e.g., PD 1013, USB power base 1113) over a wired link segment (e.g., single twisted wire pair 1091, USB cable 1191).

In an aspect, the local power sourcing device comprises power sourcing equipment such as PSE 1012 of WISP 1000 of FIG. 10. With respect to PSE 1012, it is noted that PSE 1012 is connected to local power supply 1010 from which PSE 1012 obtains power for providing to an interface unit (e.g., PD 1013) over a wired link segment (e.g., single twisted wire pair 1091).

In an aspect, the local power sourcing device comprises power sourcing equipment such as host 1011 of WISP 1100 of FIG. 11). With respect to host 1011, it is noted that the host 1011 itself provides local power to interface unknit (e.g., USB power base 1113) over a wired link segment (e.g., USB cable 1191) using its own power supply. In an aspect, host 1011 is a laptop computer, a personal computer, a server, a tablet, or so forth.

At block 1304, method 1300 includes powering, from the interface unit (e.g., PD 1013, USB power base 1113), respective sensing elements of a plurality of sensing elements 106a, 1206a. Each sensing element of the plurality of sensing elements 106a, 1206a is connected to a respective edge module of a plurality of edge modules 104a, 104b, 104c, 12104a. The plurality of edge modules 104a, 104b, 104c are connected to the interface unit (e.g., PD 1013, USB power base 1113) via a daisy-chain configuration terminated by a network terminator 142.

At block 1306, method 1300 includes collecting sensed data from each of the plurality of sensing elements 106a, 1206a via the wired link segment (e.g., single twisted wire pair 1091, USB cable 1191). In an aspect, host 1011 collects the sensed data.

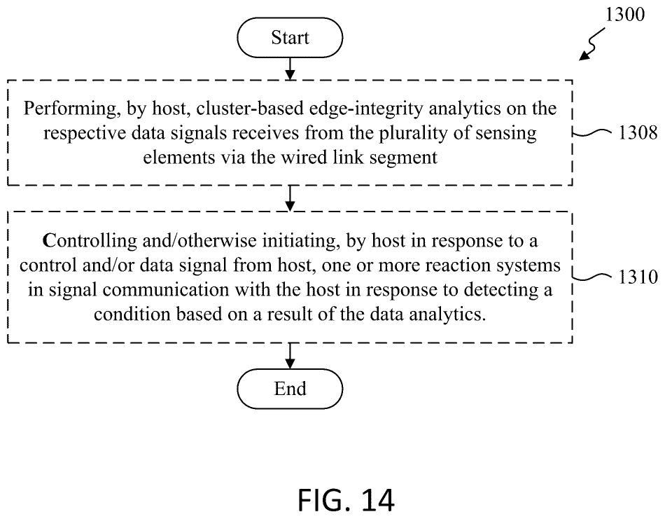

FIG. 14 shows a flow diagram further illustrating blocks of method 1300, in accordance with an example aspect.

At block 1308, method 1300 includes performing, by host 1011, cluster-based edge-integrity analytics on the respective data signals receives from the plurality of sensing elements 106a, 1206a via the wired link segment (e.g., single twisted wire pair 1091, USB cable 1191). In an aspect, the cluster-based edge-integrity analytics are performed to detect a condition from among a plurality of detectable conditions. For example, in an aspect, based on sensed deflection of a structural member as indicated from the sensor data, response data from host 1011 may include instructions for initiating and/or otherwise controlling an alert system for providing an alert of the deflection to a remote location. In this way, corrective action can be dispatched as needed. In an aspect, a table or other mapping construct may be used by host 1011 to correlate sensor values from sensors 106a with particular and different detectable conditions and corresponding courses of action.

At block 1310, method 1300 includes controlling and/otherwise initiating, by host 1011 in response to a control and/or data signal from host 1011, one or more reaction systems in signal communication with the host in response to detecting a condition based on a result of the data analytics.

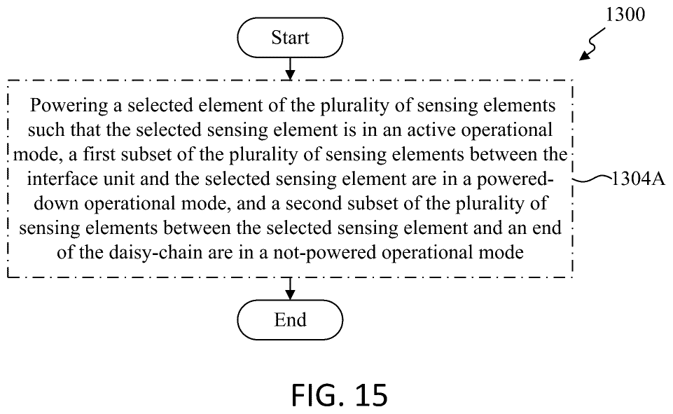

FIG. 15 shows a flow diagram further illustrating block 1304 of method 1300, in accordance with an example aspect.

In an aspect, block 1304 may include block 1304A.

At block 1304A, method 1300 includes powering a selected element of the plurality of sensing elements 106a, 1206a such that the selected sensing element is in an active operational mode, a first subset of the plurality of sensing elements 106a, 1206a between the host 1011 and the selected sensing element are in a powered-down operational mode, and a second subset of the plurality of sensing elements 106a, 1206a between the selected sensing element and an end of the daisy-chain are in a not-powered operational mode. In this way, only a single sensing element is active at any given time to preserve resources and direct the resources as needed using a daisy chain configuration as described herein.

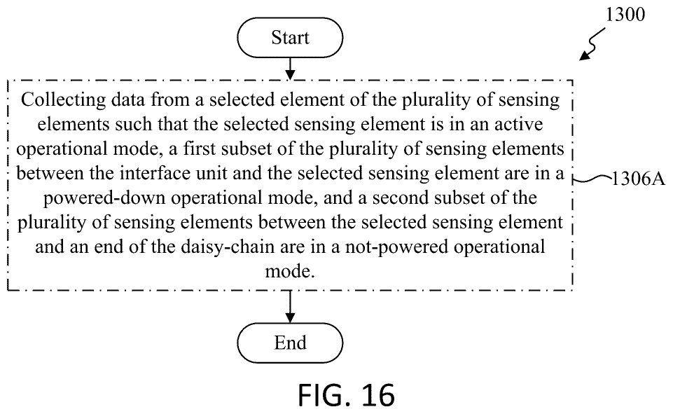

FIG. 16 shows a flow diagram further illustrating block 1306 of method 1300, in accordance with an example aspect.

In an aspect, block 1306 may include block 1306A.

At block 1304A, method 1300 includes collecting data from a selected element of the plurality of sensing elements 106a, 1206a such that the selected sensing element is in an active operational mode, a first subset of the plurality of sensing elements 106a, 1206a between host 1011 and the selected sensing element are in a powered-down operational mode, and a second subset of the plurality of sensing elements 106a, 1206a between the selected sensing element and an end of the daisy-chain are in a not-powered operational mode.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

Note that the activities discussed above with reference to the FIGURES which are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC. IP block, or SoC), non-transitory medium could include a hardware device hardware-programmed with logic to perform the methods or functions disclosed herein. The teachings could also be practiced in the form of Register Transfer Level (R1L) or other hardware description language such as VHDL or Verilog, which can be used to program a fabrication process to produce the hardware elements disclosed.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Any suitably-configured processor component can execute any type of instructions associated with the data to achieve the operations detailed herein. Any processor disclosed herein could transform an element or an article (for example, data) from one state or thing to another state or thing. In mother example, some activities outlined herein may be implemented with fixed logic or programmable logic (for example, software and/or computer instructions executed by a processor) and the elements identified herein could be some type of a programmable processor, programmable digital logic (for example, an PPGA, an erasable programmable read only memory (EPROM), an electrically erasable programmable read only memory (EEPROM)), an ASTC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some embodiments, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example embodiment, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

### Interpretation of Terms

All definitions, as defined and used herein, should be understood to control over dictionary definitions, definitions in documents incorporated by reference, and/or ordinary meanings of the defined terms. Unless the context clearly requires otherwise, throughout the description and the claims:

“comprise,” “comprising,” and the like are to be construed in an inclusive sense, as opposed to an exclusive or exhaustive sense; that is to say, in the sense of “including, but not limited to”.

“connected,” “coupled,” or any variant thereof, means any connection or coupling, either direct or indirect, between two or more elements; the coupling or connection between the elements can be physical, logical, or a combination thereof.

“herein,” “above,” “below,” and words of similar import, when used to describe this specification shall refer to this specification as a whole and not to any particular portions of this specification.

“or,” in reference to a list of two or more items, covers all of the following interpretations of the word: any of the items in the list, all of the items in the list, and any combination of the items in the list.

The singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, ‘under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion. i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one. A, and at least one, optionally including more than one, B (and optionally including other elements); etc.

As used herein, the term “between” is to be inclusive unless indicated otherwise. For example. “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting or and “consisting essentially of shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto. Applicant wishes to note that the Applicant: (a) does not intend any of the appended claims to invoke 35 U.S.C. § 112 (f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

The invention may be considered in accordance with the following clauses.
Clause 1. A system for witness integrity sensing, comprising: a plurality of structural integrity sensing elements; a plurality of edge modules, wherein each of the plurality of edge modules is connected to a respective structural integrity sensing element of the plurality of structural integrity sensing elements; an interface unit having a host interface side and a network interface side, the network interface side configured to collect daisy chain sensing network data and selectively power respective structural integrity sensing elements of the plurality of sensing elements, through selective ones of the plurality of edge modules; and a daisy-chain communication link connecting the interface unit to each of the plurality of edge modules in series, wherein each of the plurality of edge modules transmits a respective data signal to the interface unit, and wherein the daisy-chain communication link ends at a network terminator.
Clause 2. The system of clause 1, further comprising a wired link segment having a first side and a second side and being configured to carry power and data therebetween, wherein the second side of the wired link segment is connected to the network interface side of the interface unit.
Clause 3. The system of any preceding clauses, further comprising a host, connected to the first side of the wired segment, and having a processor.
Clause 4. The system of any preceding clauses, wherein the host is configured to provide power to each of the plurality of edge modules via the daisy chain communication link.
Clause 5. The system of any preceding clauses, wherein the wired link segment consists of a twisted wire pair terminated by a first connector at the first side and a second connector at the second side.
Clause 6. The system of any preceding clauses, wherein the wired link segment comprises multiple wires terminated by a first connector at the first side and a second connector at the second side.
Clause 7. The system of any preceding clauses, wherein the wired link segment uses a first twisted wire pair for data, and a second twisted wire pair for power.
Clause 8. The system of any preceding clauses, further comprising power sourcing equipment configured to receive power from a local power supply and provide the power to the first side of the wired link segment.
Clause 9. The system of any preceding clauses, wherein the power sourcing equipment comprises a 10 BASE-T1L connector configured to connect to a 10 BASE-T1L connector of the wired link segment arranged at the first side of the wired link segment.
Clause 10. The system of any preceding clauses, wherein each edge module of the plurality of edge modules is in one of an active operational mode, a not-powered operational mode, and a powered down operational mode.
Clause 11. The system of any preceding clauses, wherein when the interface powers a selected structural integrity sensing element of the plurality of structural integrity sensing elements along the daisy-chain, the selected structural integrity sensing element is in an active operational mode, a first subset of the plurality of structural integrity sensing elements between the interface and the selected structural integrity sensing element are in a powered-down mode, and a second subset of the plurality of structural integrity sensing elements between the selected structural integrity sensing element and an end of the daisy-chain communication link are in a not-powered mode.
Clause 12. The system of any preceding clauses, wherein the daisy chain communication link is an RS485 daisy chain communication link.
Clause 13. The system of any preceding clauses, wherein the daisy chain communication link is a 1-Wire® daisy chain communication link.
Clause 14. The system of any preceding clauses, wherein the daisy chain communication link consists of a single wire for data and power communication together with a ground reference.
Clause 15. The system of any preceding clauses, wherein each of the plurality of edge modules comprises: a sensor signal conditioning element configured to receive sensor data from a respective structural integrity sensing element of the plurality of structural integrity sensing elements; and an analog-to-digital converter configured to convert sensor data to a digital data signal.
Clause 16. A method for witness integrity sensing, comprising: providing power from a local power sourcing device to an interface unit over a wired link segment; powering, from the interface unit, respective sensing elements of a plurality of sensing elements, wherein each sensing element of the plurality of sensing elements is connected to a respective edge module of a plurality of edge modules, and wherein the plurality of edge modules are connected to the interface unit via a daisy-chain configuration terminated by a terminating device; and collecting sensed data from each of the plurality of sensing elements via the wired link segment.
Clause 17. The method of clause 16, wherein powering respective sensing elements comprises powering a selected element of the plurality of sensing elements, wherein the selected sensing element is in an active operational mode, a first subset of the plurality of sensing elements between the interface and the selected sensing element are in a powered-down operational mode, and a second subset of the plurality of sensing elements between the selected sensing element and an end of the daisy-chain are in a not-powered operational mode.
Clause 18. The method of any preceding clauses, wherein collecting sensed data from each of the plurality of sensing elements comprises collecting data from a selected element of the plurality of sensing elements, wherein the selected sensing element is in an active operational mode, a first subset of the plurality of sensing elements between the interface and the selected sensing element are in a powered-down operational mode, and a second subset of the plurality of sensing elements between the selected sensing element and an end of the daisy-chain are in a not-powered operational mode.
Clause 19. The method of any preceding clauses, wherein the interface unit has a host interface side and a network interface side, and the method comprises configuring the network interface side to collect daisy chain sensing network data and selectively power respective structural integrity sensing elements of the plurality of sensing elements, though selective ones of the plurality of edge modules.
Clause 20. The method of any preceding clauses, further comprising configuring a wired link segment having a first side and a second side to carry power and data therebetween, wherein the second side of the wired link segment is connected to the network interface side of the interface unit.
Clause 21. The method of any preceding clauses, further comprising configuring a host to be connected to the first side of the wired segment, wherein the host has a processor.

Various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The above description of illustrated embodiments is not intended to be exhaustive or limiting as to the precise forms disclosed. While specific implementations of, and examples for, various embodiments or concepts are described herein for illustrative purposes, various equivalent modifications may be possible, as those skilled in the relevant art will recognize. These modifications may be made in light of the above detailed description, the Figures, or the claims.

What is claimed is:

1. A system for witness integrity sensing, comprising:
a plurality of structural integrity sensing elements;
a plurality of edge modules, wherein each of the plurality of edge modules is connected to a respective structural integrity sensing element of the plurality of structural integrity sensing elements;
an interface unit having a host interface side and a network interface side, the network interface side configured to collect daisy chain sensing network data and selectively power respective structural integrity sensing elements of the plurality of sensing elements, through selective ones of the plurality of edge modules; and
a daisy-chain communication link connecting the interface unit to each of the plurality of edge modules in series, wherein each of the plurality of edge modules transmits a respective data signal to the interface unit, and wherein the daisy-chain communication link ends at a network terminator.

2. The system of claim 1, further comprising a wired link segment having a first side and a second side and being configured to carry power and data therebetween, wherein the second side of the wired link segment is connected to the network interface side of the interface unit.

3. The system of claim 2, further comprising a host, connected to the first side of the wired segment, and having a processor.

4. The system of claim 3, wherein the host is configured to provide power to each of the plurality of edge modules via the daisy chain communication link.

5. The system of claim 2, wherein the wired link segment consists of a twisted wire pair terminated by a first connector at the first side and a second connector at the second side.

6. The system of claim 2, wherein the wired link segment comprises multiple wires terminated by a first connector at the first side and a second connector at the second side.

7. The system of claim 2, wherein the wired link segment uses a first twisted wire pair for data, and a second twisted wire pair for power.

8. The system of claim 2, further comprising power sourcing equipment configured to receive power from a local power supply and provide the power to the first side of the wired link segment.

9. The system of claim 8, wherein the power sourcing equipment comprises a 10 BASE-T1L connector configured to connect to a 10 BASE-T1L connector of the wired link segment arranged at the first side of the wired link segment.

10. The system of claim 1, wherein each edge module of the plurality of edge modules is in one of an active operational mode, a not-powered operational mode, and a powered down operational mode.

11. The system of claim 1, wherein when the interface powers a selected structural integrity sensing element of the plurality of structural integrity sensing elements along the daisy-chain, the selected structural integrity sensing element is in an active operational mode, a first subset of the plurality of structural integrity sensing elements between the interface and the selected structural integrity sensing element are in a powered-down mode, and a second subset of the plurality of structural integrity sensing elements between the selected structural integrity sensing element and an end of the daisy-chain communication link are in a not-powered mode.

12. The system of claim 1, wherein the daisy chain communication link is an RS485 daisy chain communication link.

13. The system of claim 1, wherein the daisy chain communication link is a 1-Wire® daisy chain communication link.

14. The system of claim 1, wherein the daisy chain communication link consists of a single wire for data and power communication together with a ground reference.

15. The system of claim 1, wherein each of the plurality of edge modules comprises:
a sensor signal conditioning element configured to receive sensor data from a respective structural integrity sensing element of the plurality of structural integrity sensing elements; and
an analog-to-digital converter configured to convert sensor data to a digital data signal.

16. A method for witness integrity sensing, comprising:
providing power from a local power sourcing device to an interface unit over a wired link segment;
powering, from the interface unit, respective sensing elements of a plurality of sensing elements, wherein each sensing element of the plurality of sensing elements is connected to a respective edge module of a plurality of edge modules, and wherein the plurality of edge modules are connected to the interface unit via a daisy-chain configuration terminated by a terminating device; and
collecting sensed data from each of the plurality of sensing elements via the wired link segment.

17. The method of claim 16, wherein powering respective sensing elements comprises powering a selected element of the plurality of sensing elements, wherein the selected sensing element is in an active operational mode, a first subset of the plurality of sensing elements between the interface and the selected sensing element are in a powered-down operational mode, and a second subset of the plurality of sensing elements between the selected sensing element and an end of the daisy-chain are in a not-powered operational mode.

18. The method of claim 16, wherein collecting sensed data from each of the plurality of sensing elements comprises collecting data from a selected element of the plurality of sensing elements, wherein the selected sensing element is in an active operational mode, a first subset of the plurality of sensing elements between the interface and the selected sensing element are in a powered-down operational mode, and a second subset of the plurality of sensing elements between the selected sensing element and an end of the daisy-chain are in a not-powered operational mode.

19. The method of claim 16, wherein the interface unit has a host interface side and a network interface side, and the method comprises configuring the network interface side to collect daisy chain sensing network data and selectively power respective structural integrity sensing elements of the plurality of sensing elements, though selective ones of the plurality of edge modules.

20. The method of claim 19, further comprising configuring a wired link segment having a first side and a second side to carry power and data therebetween, wherein the second side of the wired link segment is connected to the network interface side of the interface unit.

21. The method of claim 20, further comprising configuring a host to be connected to the first side of the wired segment, wherein the host has a processor.
